(19) United States
(12) Patent Application Publication
(10) Pub. No.: US 2010/0213084 A1
(43) Pub. Date: Aug. 26, 2010

(54) Hydrogen Storage Device

(76) Inventor: Katsuhiko Hirose, Niwa-gun (JP)

Correspondence Address: KENYON & KENYON LLP, 1500 K STREET N.W., SUITE 700, WASHINGTON, DC, 20005, US

(21) Appl. No.: 11/990,126

(22) PCT Filed: Aug. 8, 2006
(86) PCT No.: PCT/JP2006/315987

§ 371 Date: Apr. 18, 2008

(30) Foreign Application Priority Data
Aug. 8, 2005 (JP) 2005-230076
Aug. 8, 2005 (JP) 2005-230077

(51) Int. Cl. F17C 3/02; B65D 85/00; F17C 11/00

(52) U.S. Cl. 206/7

(57) ABSTRACT

A hydrogen storage device capable of storing hydrogen for a long period of time is provided. The hydrogen storage device of the invention is provided with a thermally insulated container having an inner space, a liquid hydrogen inflow opening, and a hydrogen gas outflow opening, and a hydrogen adsorbing member filled in the inner space.

### TECHNICAL FIELD

The present invention relates to a hydrogen storage device.

### BACKGROUND ART

Recently, fuel cells and engines using hydrogen as fuel are developed, and at the same time, development of method and device for occluding or storing hydrogen to be supplied in the engines and fuel cells is being promoted.

Previously existing hydrogen storing methods include a method of storing hydrogen in a high-pressure hydrogen cylinder by applying a pressure of about 20 MPa to hydrogen, and a method of storing liquid hydrogen cooled to about 20 K in a liquid hydrogen cylinder. Further, as disclosed in Japanese Patent Application Laid-Open (JP-A) No. 2001-220101 (patent document 1), a hydrogen storage device including porous carbon material and a container accommodating the carbon material has been known.

### DISCLOSURE OF THE INVENTION

In the hydrogen storage device of patent document 1, for example, a stainless steel tank or cylinder is used as a container for storing hydrogen. However, such stainless steel tank may not sufficiently insulate the heat from outside when storing liquid hydrogen, and may not be suited to long-term storage of hydrogen.

The invention is devised in the light of the above conventional problem, and it is hence an object thereof to present a hydrogen storage device capable of storing hydrogen for a long period of time.

To achieve the object, the hydrogen storage device of the invention includes a thermally insulated container having an inner space, a liquid hydrogen inflow opening, and a hydrogen gas outflow opening, and a hydrogen adsorbing member disposed in the inner space.

Since the hydrogen storage device of the invention has a thermally insulated container, heat conduction from outside to the inner space may be suppressed, and vaporization of liquid hydrogen stored in the hydrogen storage device may be suppressed. Further, a hydrogen adsorbing member is disposed in the inner space. As a result, the inner space is filled with the hydrogen adsorbing material. The hydrogen adsorbing member disposed in the inner space adsorbs and holds hydrogen molecules. Since the hydrogen held in the hydrogen adsorbing member is maintained within the device even after all of liquid hydrogen stored in the hydrogen storage device is evaporated, the hydrogen storage device of the invention may store hydrogen for a long period of time.

The hydrogen adsorbing member of the invention is a member composed of a substance for adsorbing and holding hydrogen molecules (hydrogen adsorbing material) on its surface, and this substance should be distinguished from a hydrogen absorbing alloy for absorbing by capturing atomic hydrogen.

In the hydrogen storage device of the invention, the hydrogen adsorbing member may be disposed so as to occupy a part of the inner space. As a result, a part of the inner space is filled with the hydrogen occluding material. By disposing the hydrogen adsorbing member so as to occupy a part of the inner space, a portion free from hydrogen adsorbing member is allowed in the inner space (a liquid hydrogen storage space mentioned below), and the filling amount of liquid hydrogen in the inner space is increased.

In the hydrogen storage device of the invention, the hydrogen adsorbing member may be disposed so as to occupy 5 to 30% of the inner space. If the occupied space by the hydrogen adsorbing member is 30% or less, the filling amount of liquid hydrogen is sufficient. If the occupied space by the hydrogen adsorbing member is 5% or more, the amount of hydrogen held in the hydrogen adsorbing member is sufficient. More preferably, the hydrogen adsorbing member occupies 10 to 25% of the inner space.

When the hydrogen adsorbing member is disposed in a part of the inner space, the hydrogen adsorbing member may be disposed at the side opposite the gravitational direction when the inner space is divided so that the volume is 1:1 by an orthogonal plane to a vertical line (that is, in the upper part of the hydrogen storage device). By disposing the hydrogen storage device of the invention in such configuration, a portion free from hydrogen adsorbing member may be provided at the gravitational direction side (that is, in the lower part of the hydrogen storage device). By filling the portion free from hydrogen adsorbing member with liquid hydrogen, vaporization of liquid hydrogen due to contact of liquid hydrogen with the hydrogen adsorbing member is suppressed, and the filling efficiency of liquid hydrogen may be increased.

The hydrogen gas occurring when filling with liquid hydrogen is adsorbed and held in the hydrogen adsorbing member disposed in the upper part of the hydrogen storage device. The hydrogen adsorbing member generates heat of adsorption when the hydrogen gas is adsorbed, but the hydrogen gas generated at the time of filling is nearly equivalent to liquid hydrogen temperature (20.4 K), and this hydrogen gas of low temperature deprives of the heat of adsorption, and temperature rise in the hydrogen storage device may be suppressed.

When the hydrogen adsorbing member is disposed at the side opposite the gravitational direction, a hydrogen gas outflow opening may be disposed so as to make it possible to take out the hydrogen adsorbed in the hydrogen adsorbing member. As a result, the vaporized hydrogen may be taken out firstly. To take out the hydrogen adsorbed in the hydrogen adsorbing member, for example, a hydrogen gas outflow opening may be disposed at the location of the hydrogen adsorbing member is disposed.

When the hydrogen adsorbing member is disposed in a part of the inner space, the hydrogen adsorbing member may be disposed at the gravitational direction side when the inner space is divided so that the volume is 1:1 by an orthogonal plane to a vertical line (that is, in the lower part of the hydrogen storage device). By disposing the hydrogen adsorbing member in the lower part of the hydrogen storage device, hydrogen may be sufficiently adsorbed in the hydrogen adsorbing member. As a result, if the liquid hydrogen is lost from the device, much hydrogen may be maintained.

In the hydrogen storage device of the invention, a liquid hydrogen feed pipe for communicating between a portion of the inner space not disposed with the hydrogen adsorbing member, and the liquid hydrogen inflow opening may be further included. In such configuration, when supplying liquid hydrogen in the hydrogen storage device, the liquid hydrogen does not contact with the hydrogen adsorbing member, so that the filling efficiency of liquid hydrogen may be increased.

In the invention, a liquid hydrogen feed pipe served as the liquid hydrogen inflow opening for feeding liquid hydrogen into a space surrounded by an inner wall of the thermally insulated container and the hydrogen adsorbing member (this space may be called a liquid hydrogen storage space), and a hydrogen gas exhaust pipe served as the hydrogen gas outflow opening for exhausting hydrogen gas generated from the liquid hydrogen from the thermally insulated container may be further included, and the liquid hydrogen feed pipe, the hydrogen adsorbing member, and the hydrogen gas exhaust pipe may be disposed so that the hydrogen gas is exhausted from the thermally insulated container after it has passed through the hydrogen adsorbing member.

When the liquid hydrogen passing through the liquid hydrogen feed pipe is introduced into the liquid hydrogen storage space, it contacts with the inner wall of the thermally insulated container, and the liquid hydrogen boils and generates hydrogen gas. This hydrogen gas passes through the hydrogen adsorbing member, and is exhausted from the hydrogen gas exhaust pipe. The temperature of hydrogen gas generated by boiling of liquid hydrogen is nearly equivalent to the boiling point of liquid hydrogen (20.4 K), and this hydrogen gas of low temperature deprives the hydrogen adsorbing member of heat when passing through the hydrogen adsorbing member, and is exhausted outside of the thermally insulated container. As a result, the heat in the thermally insulated container can be efficiently released out of the container.

Moreover, when the hydrogen gas passes through the hydrogen adsorbing member, it is partly adsorbed and held in the hydrogen adsorbing member. The hydrogen held in the hydrogen adsorbing member is maintained within the device even after all liquid hydrogen stored in the hydrogen storage device is evaporated away, and the hydrogen storage device of the invention may stored the hydrogen for a long period of time.

The hydrogen storage device of the invention may further include a partition member for separating the hydrogen adsorbing member and the liquid hydrogen storage space. By the use of the partition member, direct contact of liquid hydrogen and hydrogen adsorbing member may be suppressed when supplying the liquid hydrogen. As a result, bumping of liquid hydrogen may be prevented.

In the hydrogen storage device of the invention, the hydrogen adsorbing member and the liquid hydrogen storage space maybe disposed in a horizontal direction in the thermally insulated container. In this case, in the hydrogen storage device of the invention, the partition member is disposed to separate the hydrogen adsorbing member and the liquid hydrogen storage space. By disposing the hydrogen adsorbing member and the liquid hydrogen storage space in the horizontal direction, the degree of freedom of layout of the hydrogen storage device may be extended.

In the hydrogen storage device of the invention, a barrier wall may be disposed in the hydrogen adsorbing member so that the hydrogen gas may pass through the hydrogen adsorbing member while meandering. By the meandering motion of hydrogen gas in the hydrogen adsorbing member, the contact area of hydrogen adsorbing member and hydrogen gas is increased, and the hydrogen adsorbing faculty may be increased.

In the hydrogen storage device of the invention, slits may be formed in the hydrogen adsorbing member. When slits are formed in the hydrogen adsorbing member, the surface area of the hydrogen adsorbing member is increased. Hence, the speed of heat exchange between hydrogen gas and hydrogen adsorbing member, and the speed of adsorption of hydrogen gas may be enhanced.

The hydrogen adsorbing member used in the hydrogen storage device of the invention may include activated carbon, carbon nano tubes, or porous metal-organic framework (MOF). An example of the porous metal-organic framework is Zn₄O (1,4-benzene dicarboxylic acid dimethyl)₃.

As described herein, the invention presents a hydrogen storage device capable of storing hydrogen for a long period of time.

### BRIEF DESCRIPTION OF THE DRAWINGS

FIG. 1A is a perspective view of a hydrogen storage device in a first exemplary embodiment of the invention.

FIG. 1B is a sectional view along line A-A of the hydrogen storage device in the first exemplary embodiment of the invention.

FIG. 2A is a perspective view of a hydrogen storage device in a second exemplary embodiment of the invention.

FIG. 2B is a sectional view along line C-C of the hydrogen storage device in the second exemplary embodiment of the invention.

FIG. 3A is a perspective view of a hydrogen storage device in a third exemplary embodiment of the invention.

FIG. 3B is a sectional view along line A-A of the hydrogen storage device in the third exemplary embodiment of the invention.

FIG. 4 is a sectional view along line A-A of the hydrogen storage device in a first modified example of the third exemplary embodiment of the invention.

FIG. 5 is a sectional view along line A-A of the hydrogen storage device in a second modified example of the third exemplary embodiment of the invention.

FIG. 6A is a perspective view of a hydrogen storage device in a fourth exemplary embodiment of the invention.

FIG. 6B is a sectional view along line B-B of the hydrogen storage device in the fourth exemplary embodiment of the invention.

FIG. 7A is a perspective view of a hydrogen storage device in a fifth exemplary embodiment of the invention.

FIG. 7B is a sectional view along line C-C of the hydrogen storage device in the fifth exemplary embodiment of the invention.

### BEST MODE FOR CARRYING OUT THE INVENTION

The hydrogen storage device of the invention is described below while referring to the accompanying drawings.

### First Exemplary Embodiment

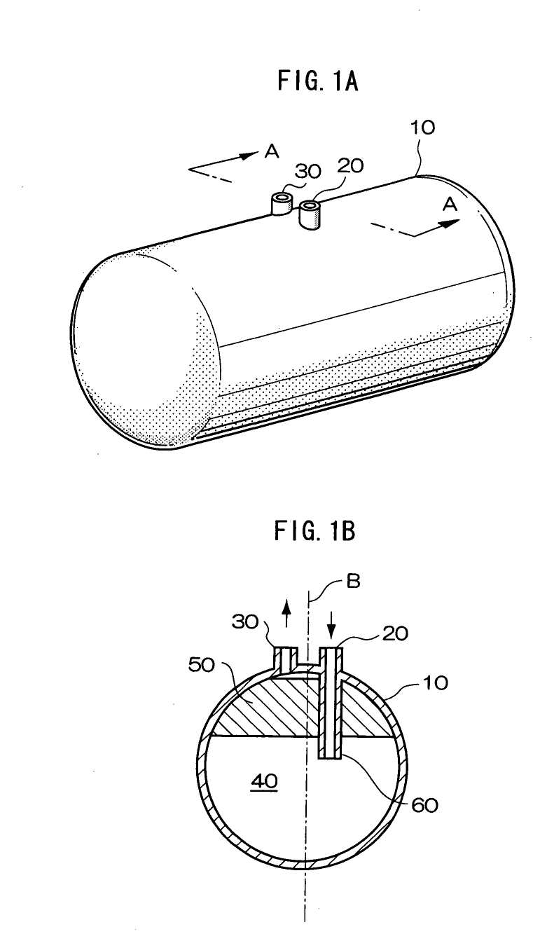

FIG. 1A is a perspective view of a hydrogen storage device in a first exemplary embodiment of the invention, and FIG. 1B is a sectional view along line A-A of FIG. 1A.

The hydrogen storage device in the first exemplary embodiment includes a thermally insulated container 10, a liquid hydrogen inflow opening 20 and a hydrogen gas outflow opening 30 disposed in the upper part of the thermally insulated container 10. A hydrogen adsorbing member 50 is disposed at the side opposite the gravitational direction when an inner space 40 of the thermally insulated container 10 is divided so that the volume is 1:1 by an orthogonal plane to a vertical line B (that is, in the upper part of the hydrogen storage device). The liquid hydrogen inflow opening 20 and a portion of the inner space 40 not disposed with the hydrogen adsorbing member 50 communicate with each other by a liquid hydrogen feed pipe 60. The hydrogen gas outflow opening 30 is disposed in the upper part of the thermally insulated container 10 so that the hydrogen adsorbed in the hydrogen adsorbing member 50 may be taken out.

The thermally insulated container 10 may be, for example, a tank of SUS or stainless steel having a heat insulating material (multi-layer insulator: MLI) provided on the outer side, but is not limited to this example.

The MLI is composed by alternately laminating a radiation shield material of thin film of high reflectivity and a spacer material for preventing heat conduction between shield materials. Shield materials include polyester film having one side or both sides evaporated with aluminum, and others, and spacer materials include glass fiber cloth or paper, nylon net and others. The MLI decreases the incoming heat by radiation by 1/(N+1) where N is the number of shield materials.

The hydrogen adsorbing material for composing the hydrogen adsorbing member 50 includes activated carbon, carbon nano tubes, MOF (porous metal-organic framework) such as Zn₄O (1,4-benzene dicarboxylic acid dimethyl)₃, and others. These materials are used as granules, pellets, or power of materials contained in pouch. In the exemplary embodiment, pellets of activate carbon are used.

The inner space 40 is partitioned by metal mesh or the like, and pellets of activated carbon are disposed in a partition.

Operations of constituent members for storing liquid hydrogen in the hydrogen storage device in the first exemplary embodiment are explained.

The liquid hydrogen poured in from the liquid hydrogen inflow opening 20 is supplied in the inner space 40 where the hydrogen adsorbing member 50 is not disposed through the liquid hydrogen feed pipe 60. The liquid hydrogen supplied through the liquid hydrogen feed pipe 60 does not contact directly with the hydrogen adsorbing member 50. Part of the supplied liquid hydrogen is vaporized, and produces hydrogen gas near the liquid hydrogen temperature, somewhat depending on the temperature in the inner space 40 or temperature of the inner wall of the thermally insulated container 10. This hydrogen gas cools the inner space 40 and hydrogen adsorbing member 50, and is exhausted from the hydrogen gas outflow opening 30, and is partly adsorbed and held in the hydrogen adsorbing member 50. When the hydrogen gas is adsorbed in the hydrogen adsorbing member 50, heat of adsorption is generated, but since it is cooled by the hydrogen gas near the liquid hydrogen temperature, and temperature rise in the inner space 40 and hydrogen adsorbing member 50 is suppressed.

As the inner space 40 is cooled, vaporization of liquid hydrogen calms down, and the liquid hydrogen is filled into the inner space 40. The filling amount of the liquid hydrogen is properly determined in consideration of the expansion rate of liquid hydrogen. After the hydrogen is sufficiently adsorbed in the hydrogen adsorbing member 50, the liquid hydrogen may come to contact with the hydrogen adsorbing member 50. This is because heat of adsorption is not generated if the hydrogen adsorbing member 50 sufficiently adsorbing the hydrogen contacts with the liquid hydrogen, and the liquid hydrogen does not boil. In this case, the portion filled with the hydrogen adsorbing member 50 may be utilized as a shock absorbing space of expanded liquid hydrogen.

The hydrogen storage device of the first exemplary embodiment prevents bumping due to direct contact between liquid hydrogen and hydrogen adsorbing member 50, and hence shortens the filling time of liquid hydrogen.

The hydrogen stored in the hydrogen storage device is taken out from the hydrogen gas outflow opening 30, and is used. For the ease of taking out the hydrogen, a heater may be disposed in the inner space 40. If the liquid hydrogen stored in the inner space 40 is used up, since the hydrogen is adsorbed in the hydrogen adsorbing member 50, the hydrogen storage device of the invention can store hydrogen for a long period of time.

### Second Exemplary Embodiment

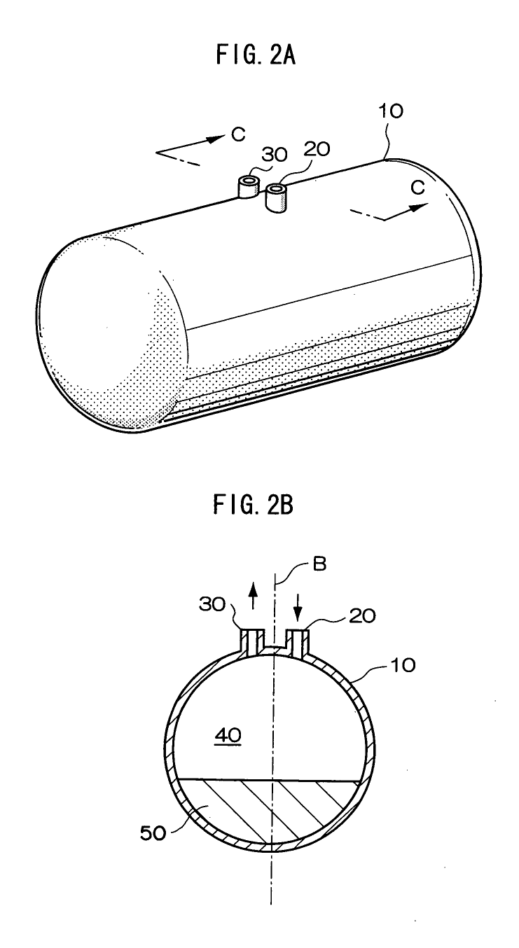

A hydrogen storage device in a second exemplary embodiment of the invention is described. FIG. 2A is a perspective view of the hydrogen storage device in the second exemplary embodiment of the invention, and FIG. 2B is a sectional view along line C-C of FIG. 2A. The hydrogen storage device in the second exemplary embodiment includes a thermally insulated container 10, a liquid hydrogen inflow opening 20 and a hydrogen gas outflow opening 30 disposed in the upper part of the thermally insulated container 10. A hydrogen adsorbing member 50 is disposed at the gravitational direction side when an inner space 40 of the thermally insulated container 10 is divided so that the volume is 1:1 by an orthogonal plane to a vertical line B (that is, in the lower part of the hydrogen storage device). The thermally insulated container 10 and hydrogen adsorbing member 50 may be same as in the first exemplary embodiment. In this exemplary embodiment, pellets of activated carbon are used, and disposed same as in the first exemplary embodiment.

The liquid hydrogen poured in from the liquid hydrogen inflow opening 20 is supplied in the inner space 40. If there is a risk of bumping of the liquid hydrogen due to contact with the hydrogen adsorbing member 50, it is preferred to cool the hydrogen adsorbing member 50 preliminarily. A cooling method is desired to cool by gradually supply small portions of liquid hydrogen into the inner space 40. The hydrogen stored in the hydrogen storage device is taken out from the hydrogen gas outflow opening 30, and is used. The hydrogen adsorbing member 50 of the second exemplary embodiment contacts with liquid hydrogen, and adsorbs and holds much hydrogen. Hence if the liquid hydrogen is used up, the hydrogen storage device of the invention can store hydrogen for a long period of time.

The hydrogen storage device of the invention may be further disposed with a release valve for suppressing elevation of internal pressure of the thermally insulated container. Moreover, the hydrogen adsorbing member may be disposed both at the side opposite the gravitational direction (that is, in the upper part of the hydrogen storage device), and at gravitational direction side (that is, in the lower part of the hydrogen storage device) when the inner space of the thermally insulated container is divided so that the volume is 1:1 by an orthogonal plane to a vertical line.

### Third Exemplary Embodiment

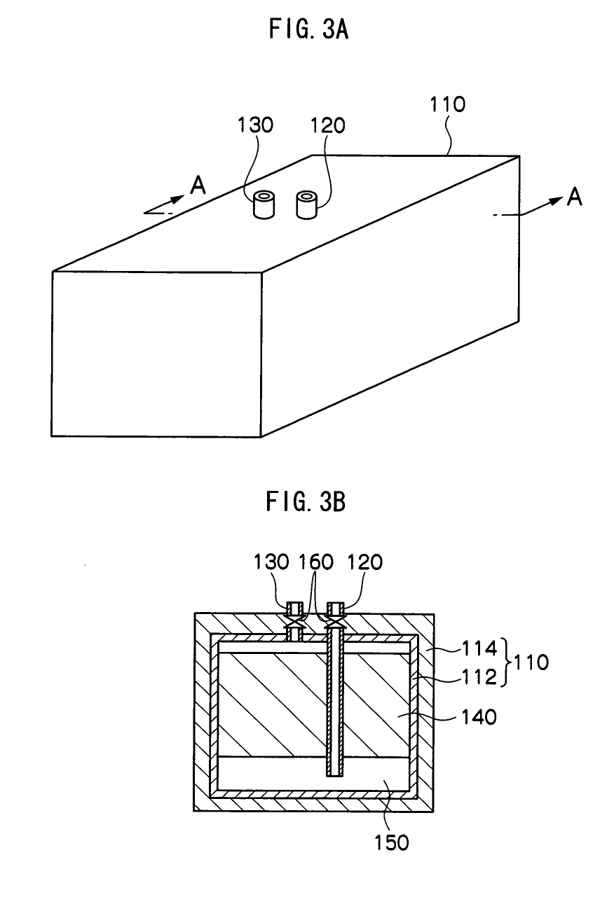

FIG. 3A is a perspective view of a hydrogen storage device in a third exemplary embodiment of the invention, and FIG. 3B is a sectional view along line A-A of FIG. 3A. The hydrogen storage device in the third exemplary embodiment includes a thermally insulated container 110, a liquid hydrogen feed pipe 120 and a hydrogen gas exhaust pipe 130 disposed in the upper part of the thermally insulated container 110. In this exemplary embodiment, the liquid hydrogen feed pipe 120 corresponds to the liquid hydrogen inflow opening, and the hydrogen gas exhaust pipe 130 corresponds to the hydrogen gas outflow opening.

The thermally insulated container 110 is composed of a tank 112 and a heat insulating material 114 covering the outer side of the tank 112 as shown in FIG. 3B.

The tank 112 may be SUS or stainless steel tank, but is not limited to this example.

The heat insulating material 114 may be a multi-layer insulator (MLI). Specific examples of MLI are same as in the first exemplary embodiment.

A hydrogen adsorbing member 140 is disposed inside of the thermally insulated container 110. Specific examples of hydrogen adsorbing material for composing the hydrogen adsorbing member 140 may be same as in the first exemplary embodiment.

A liquid hydrogen storage space 150, a space surrounded by the inner wall of the thermally insulated container 110 and the hydrogen adsorbing member 140 communicates with the liquid hydrogen feed pipe 120, and the liquid hydrogen may be supplied into the thermally insulated container 110 without directly contacting with the hydrogen adsorbing member 140.

The liquid hydrogen feed pipe 120 and hydrogen gas exhaust pipe 130 are, respectively, disposed with a valve 160. The valve 160 is covered with the heat insulating material 114, thereby preventing invasion of heat by hydrogen gas as heat medium.

Operations of constituent members for storing liquid hydrogen in the hydrogen storage device in the third exemplary embodiment are explained.

When the liquid hydrogen is supplied in the liquid hydrogen storage space 150 through the liquid hydrogen feed pipe 120, somewhat depending on the temperature of the inner wall of the tank 112, part of the liquid hydrogen is vaporized, and produces hydrogen gas near the liquid hydrogen temperature. The hydrogen gas passes through the hydrogen adsorbing member 140, and is exhausted from the thermally insulated container 110 through the hydrogen gas exhaust pipe 130. When passing through the hydrogen adsorbing member 140, heat exchange takes place between the hydrogen gas and the hydrogen adsorbing member 140, and the hydrogen adsorbing member 140 is cooled, and is partly adsorbed and held in the hydrogen adsorbing member 140. The hydrogen gas deprives the hydrogen adsorbing member 140 of heat, and is exhausted from the thermally insulated container 110, so that the inside of the thermally insulated container 110 may be efficiently cooled. Heat of adsorption occurs when the hydrogen gas is adsorbed in the hydrogen adsorbing member 140, but the heat of adsorption is also exhausted from the thermally insulated container 110 by the hydrogen gas exhausted from the thermally insulated container 110.

As the inner wall of the tank 112 is cooled, vaporization of liquid hydrogen calms down, and the liquid hydrogen is stored in the liquid hydrogen storage space 150. The hydrogen adsorbing member 140 composed of pellets of activated carbon has gaps among pellets, and the liquid hydrogen can be accumulated in the thermally insulated container 110 more than the volume of the liquid hydrogen storage space 150. After the hydrogen is sufficiently adsorbed in the hydrogen adsorbing member 140, if the liquid hydrogen contacts with the hydrogen adsorbing member 140, heat of adsorption is not generated, and bumping of liquid hydrogen is prevented.

By using the hydrogen adsorbing member 140 composed of pellets of activated carbon, pressure loss can be reduced, and the filling time of liquid hydrogen is shortened.

After finishing supply of liquid hydrogen, the liquid hydrogen may boil due to invasion of heat into the thermally insulated container 110 from outside when storing the liquid hydrogen, and hydrogen gas near the liquid hydrogen temperature may be further generated. In such a case, too, after passing through the hydrogen adsorbing member 140, the hydrogen gas is exhausted from the thermally insulated container 110, so that the inside of the thermally insulated container 110 may be cooled efficiently.

Thus, according to the hydrogen storage device of the invention, since the hydrogen gas near the liquid hydrogen temperature may be used effectively for cooling of the inside of the thermally insulated container 110, and the storage efficiency of liquid hydrogen is enhanced, and the liquid hydrogen may be stored for a long period of time.

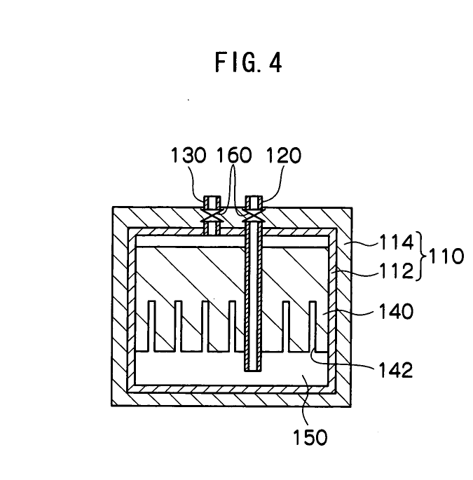

A modified example of the hydrogen storage device of the third exemplary embodiment is described. FIG. 4 is a sectional view along line A-A of the hydrogen storage device in the first modified example of the third exemplary embodiment. In the hydrogen adsorbing member 140 in FIG. 4, slits 142 are formed. As a result, the speed of heat exchange between hydrogen gas and hydrogen adsorbing member 140, and the speed of adsorption of hydrogen gas may be enhanced, so that the speed of supply of liquid hydrogen may be increased.

Instead of forming the slits 142 in the hydrogen adsorbing member 140, the pellets may be disposed so that the diameter of pellets of activated carbon for composing the hydrogen adsorbing member 140 may be smaller as going from the liquid hydrogen storage space 150 side toward the hydrogen gas exhaust pipe 130 side. As a result, the same effects as when the slits 142 are formed in the hydrogen adsorbing member 140 may be obtained.

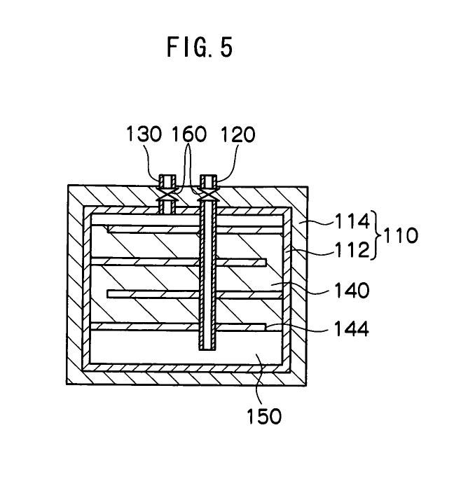

FIG. 5 is a sectional view along line A-A of the hydrogen storage device in a second modified example of the third exemplary embodiment. A barrier wall 144 is disposed in the hydrogen adsorbing member 140 so that the hydrogen gas may pass through the hydrogen adsorbing member 140 while meandering. As a result, the speed of heat exchange between hydrogen gas and hydrogen adsorbing member 140, and the speed of adsorption of hydrogen gas may be enhanced, so that the speed of supply of liquid hydrogen may be increased.

### Fourth Exemplary Embodiment

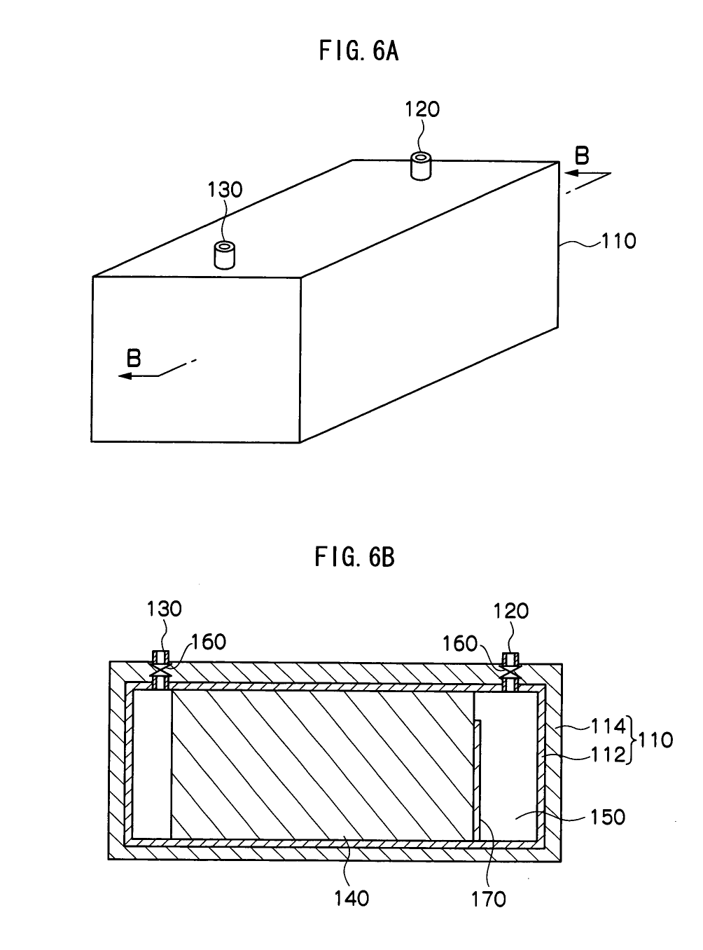

FIG. 6A is a perspective view of a hydrogen storage device in a fourth exemplary embodiment of the invention, and FIG. 6B is a sectional view along line B-B of FIG. 6A. In the hydrogen storage device of the fourth exemplary embodiment, the hydrogen adsorbing member 140 and liquid hydrogen storage space 150 are disposed in a horizontal direction. A partition member 170 separates the hydrogen adsorbing member 140 and the liquid hydrogen storage space 150, and when the liquid hydrogen is supplied from the liquid hydrogen feed pipe 120, direct contact of liquid hydrogen and hydrogen adsorbing member 140 may be prevented. Hence, bumping of liquid hydrogen due to heat of adsorption is prevented, and the speed of supply of liquid hydrogen is enhanced.

By disposing the hydrogen storage device of the invention in such conformation, the shape of the tank 112 may be reduced in thickness. And it is convenient for mounting when this hydrogen storage device is used as a fuel tank for a fuel cell car.

### Fifth Exemplary Embodiment

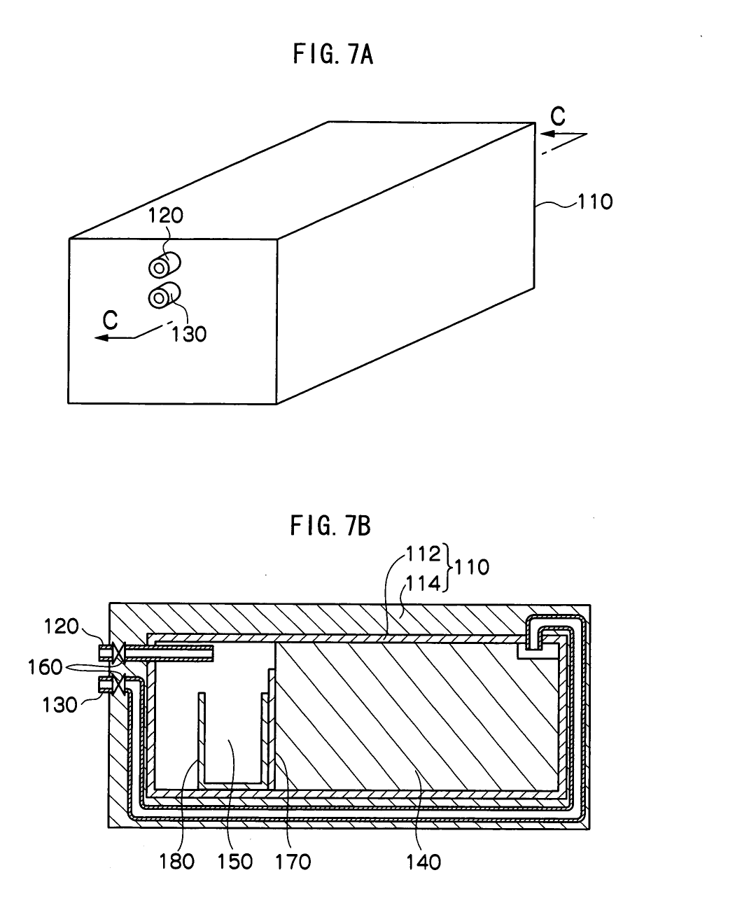

FIG. 7A is a perspective view of a hydrogen storage device in a fifth exemplary embodiment of the invention, and FIG. 7B is a sectional view along line C-C of FIG. 7A. In the hydrogen storage device of the fifth exemplary embodiment, the hydrogen adsorbing member 140 and liquid hydrogen storage space 150 are disposed in a horizontal direction.

The liquid hydrogen storage space 150 is disposed with a cylindrical liquid hydrogen receiving tray 180. The bottom of the liquid hydrogen receiving tray 180 contacts with the tank 112. The liquid hydrogen receiving tray 180 may be formed of SUS material or aluminum.

The liquid hydrogen supplied through the liquid hydrogen feed pipe 120 is first stored in the liquid hydrogen receiving tray 180. Since the liquid hydrogen receiving tray 180 is lower in heat capacity as compared with the tank 112, bumping of liquid hydrogen may be suppressed. Further, since the bottom of the liquid hydrogen receiving tray 180 and the tank 112 are in mutual contact, the liquid hydrogen receiving tray 180 may promote heat transfer from the liquid hydrogen to the tank 112.

The hydrogen storage devices in the third to fifth exemplary embodiments are provided with gaps communicating with the hydrogen gas exhaust pipe 130, and these gaps are intended to promote efficiency of exhaust of hydrogen gas, and these gaps are not always required in the invention.

Hydrogen gas may be taken out from the hydrogen gas exhaust pipe 130, or a hydrogen outlet pipe of a smaller bore than the hydrogen gas exhaust pipe 130 may be disposed, and the hydrogen gas may be released from the hydrogen gas exhaust pipe 130 when supplying liquid hydrogen (if necessary to release a large volume of hydrogen gas), or the hydrogen gas may be taken out from the hydrogen outlet pipe when using the hydrogen gas (if necessary to release a small volume of hydrogen gas).

In the invention, the ratio of the volume occupied by the hydrogen adsorbing member 140 and the volume occupied by the liquid hydrogen storage space 150 in the thermally insulated container 110 is not specifically limited, but may be properly determined in consideration of the purpose of use of the hydrogen storage device or other factors.

In the invention, preferably, a passage (liquid hydrogen feed pipe/hydrogen gas exhaust pipe) for connecting between the inner space (liquid hydrogen storage space) and the outside is disposed so as to surround the outside of the tank. Specifically, the hydrogen gas exhaust pipe 130 in FIG. 7B is wound around the tank 112. When wound around the tank main body by plural turns, the distance of the passage may be extended. As a result, transmission of external heat to the inner space (liquid hydrogen storage space) may be suppressed.

The disclosure in Japanese Patent Application No. 2005-230076 and No. 2005-230077 is incorporated by reference herein.

All publication, patent applications, and technical standards mentioned in this specification are herein incorporated by reference to the same extent as if each individual publication, patent application, or technical standard was specifically and individually indicated to be incorporated by reference.

### INDUSTRIAL APPLICABILITY

The hydrogen storage device of the invention is capable of storing hydrogen for a long period of time, and is preferably used as a hydrogen storage device for fuel cell car using hydrogen as fuel.

1. A hydrogen storage device comprising:
a thermally insulated container having an inner space, a liquid hydrogen inflow opening, and
a hydrogen gas outflow opening, and
a hydrogen adsorbing member disposed in the inner space.

2. The hydrogen storage device of claim 1, wherein the hydrogen adsorbing member is disposed to occupy a part of the inner space.

3. The hydrogen storage device of claim 2, wherein the hydrogen adsorbing member is disposed to occupy 5 to 30% of the inner space.

4. The hydrogen storage device of claim 2, wherein the hydrogen adsorbing member is disposed at the side opposite the gravitational direction when the inner space is divided so that the volume is 1:1 by an orthogonal plane to a vertical line.

5. The hydrogen storage device of claim 4, wherein the hydrogen gas outflow opening is disposed so as to make it possible to take out the hydrogen adsorbed by the hydrogen adsorbing member.

6. The hydrogen storage device of claim 2, wherein the hydrogen adsorbing member is disposed at the gravitational direction side when the inner space is divided so that the volume is 1:1 by an orthogonal plane to a vertical line.

7. The hydrogen storage device of claim 2, further comprising a liquid hydrogen feed pipe for communicating between a portion of the inner space not disposed with the hydrogen adsorbing member, and the liquid hydrogen inflow opening.

8. The hydrogen storage device of claim 1, further comprising:
a liquid hydrogen feed pipe serving as the liquid hydrogen inflow opening for feeding liquid hydrogen into a space surrounded by an inner wall of the thermally insulated container and the hydrogen adsorbing member, and
a hydrogen gas exhaust pipe serving as the hydrogen gas outflow opening for exhausting hydrogen gas generated from the liquid hydrogen from the thermally insulated container,
wherein the liquid hydrogen feed pipe, the hydrogen adsorbing member, and the hydrogen gas exhaust pipe are disposed so that hydrogen gas is exhausted from the thermally insulated container after it has passed through the hydrogen adsorbing member.

9. The hydrogen storage device of claim 8, further comprising a partition member for separating the hydrogen adsorbing member and the inner space.

10. The hydrogen storage device of claim 9, wherein the hydrogen adsorbing member and the inner space are disposed in a horizontal direction in the thermally insulated container.

11. The hydrogen storage device of claim 8, wherein a barrier wall is disposed in the hydrogen adsorbing member so that the hydrogen gas passes through the hydrogen adsorbing member while meandering.

12. The hydrogen storage device of claim 8, wherein slits are formed in the hydrogen adsorbing member.

13. The hydrogen storage device of claim 1, wherein the hydrogen adsorbing member is activated carbon, carbon nano tubes, or porous metal-organic framework.

14. The hydrogen storage device of claim 13, wherein the porous metal-organic framework is Zn₄O (1,4-benzene dicarboxylic acid dimethyl)₃.
